(19) United States
(12) Patent Application Publication
(10) Pub. No.: US 2021/0362993 A1
(43) Pub. Date: Nov. 25, 2021

(54) TOUCH-LESS BEVERAGE DISPENSER

(71) Applicant: Smart Soda Holdings, Inc., Beachwood, OH (US)

(72) Inventors: Lior Shafir, Beachwood, OH (US); Eliyahou Shafir, Ein Vered (IL)

(21) Appl. No.: 17/324,205

(22) Filed: May 19, 2021

Related U.S. Application Data
(60) Provisional application No. 63/026,813, filed on May 19, 2020.

(51) Int. Cl. B67D 1/00; B67D 1/08; B67D 1/12

(52) U.S. Cl. CPC B67D 1/0019; B67D 1/0018; B67D 1/0888; B67D 1/1243; B67D 2210/00104; B67D 1/0074; B67D 2210/00089; B67D 2210/00123; B67D 2210/00125; B67D 1/0884

(57) ABSTRACT

Beverage dispensers, systems, and methods are provided for producing a beverage flavored mixture/solution based on instructions from a mobile device (also referred to as an electronic device) and without requiring a user to touch the beverage dispenser (e.g., reducing the spread of germs through touching shared surfaces). The beverage dispensers, systems, and methods described may also be advantageous in allowing for monitoring of use of a beverage dispenser, billing users, and tracking liquid intake. The beverage dispensers, systems, and methods may enable a greater tracking and control compared to conventional beverage dispensers.

### RELATED APPLICATIONS

This application claims the benefit of U.S. 63/026,813 filed on May 19, 2020. Which is herein incorporated by reference in its entirety.

### FIELD OF INVENTION

The present invention relates to a beverage dispenser and more particularly to system for controlling a beverage dispenser using an application running on a mobile device.

### SUMMARY

In a general embodiment, the present disclosure provides beverage dispensers, systems, and methods for producing a beverage flavored mixture/solution based on instructions from a mobile device (also referred to as an electronic device) and without requiring a user to touch the beverage dispenser (e.g., reducing the spread of germs through touching shared surfaces).

In one embodiment, the beverage dispensers, systems, and methods described are also advantageous in allowing for monitoring of use of a beverage dispenser, billing users, and tracking liquid intake. For example, the beverage dispensers, systems, and methods may enable a greater tracking and control compared to conventional beverage dispensers.

### BRIEF DESCRIPTION OF THE DRAWINGS

The annexed drawings, which are not necessarily to scale, show various aspects of the invention in which similar reference numerals are used to indicate the same or similar parts in the various views.

FIG. 1 is a photograph of an exemplary embodiment of a beverage dispenser.

FIG. 2 is a photograph of an exemplary embodiment of a mobile device.

FIG. 3 is a schematic drawing of a beverage dispenser system.

FIG. 4 is a schematic drawing showing an exemplary embodiment of a beverage dispenser and a control system.

FIG. 5 is a schematic drawing showing the beverage dispenser and the control system of FIG. 4 according to another exemplary embodiment including a liquid additive supply.

FIG. 6 is a schematic drawing showing the control system of FIG. 5.

FIG. 7 is a schematic drawing showing the beverage dispenser of FIG. 4 according to another exemplary embodiment in which a liquid supply line and a flavored product supply are cooled.

FIG. 8 is a schematic drawing showing the beverage dispenser of FIG. 4 according to another exemplary embodiment in which the liquid supply line and the flavored product supply are cooled and pumped to a mixing receptacle of the beverage dispenser.

FIG. 9 is a schematic drawing showing the beverage dispenser of FIG. 4 according to another exemplary embodiment in which the liquid supply is carbonated.

FIG. 10 is a schematic drawing showing another exemplary control system for controlling a beverage dispenser.

FIG. 11 is a schematic drawing showing a flowchart for a method of controlling an amount of a flavored product in a flavored mixture of the flavored product and a liquid that is dispensed from a beverage dispenser.

The present invention is described below in detail with reference to the drawings. In the drawings, each element with a reference number is similar to other elements with the same reference number independent of any letter designation following the reference number. In the text, a reference number with a specific letter designation following the reference number refers to the specific element with the number and letter designation and a reference number without a specific letter designation refers to all elements with the same reference number independent of any letter designation following the reference number in the drawings.

### DETAILED DESCRIPTION

The principles described herein may be used in beverage dispensing applications. Exemplary applications include beverage dispensing machines in which instructions for dispensing a beverage from the beverage dispenser are received from a mobile device. The principles described herein may be sized down for use in home beverage dispensers or sized up for use in industrial beverage dispensers. Many different flavors and liquids may be suitable for use with the beverage dispensing machine and control system described herein. Exemplary beverages (also referred to as flavored mixtures) include any suitable combinations of water, carbonated water, alkaline water, syrup, soda, other carbonated beverages, tea, coffee, and powders or solutions of flavored products.

The beverage dispensers, systems, and methods described herein are advantageous in producing a beverage flavored mixture/solution based on instructions from a mobile device (also referred to as an electronic device) and without requiring a user to touch the beverage dispenser (e.g., reducing the spread of germs through touching shared surfaces). The beverage dispensers, systems, and methods described are also advantageous in allowing for monitoring of use of a beverage dispenser, billing users, and tracking liquid intake. The beverage dispensers, systems, and methods enable a greater tracking and control compared to conventional beverage dispensers.

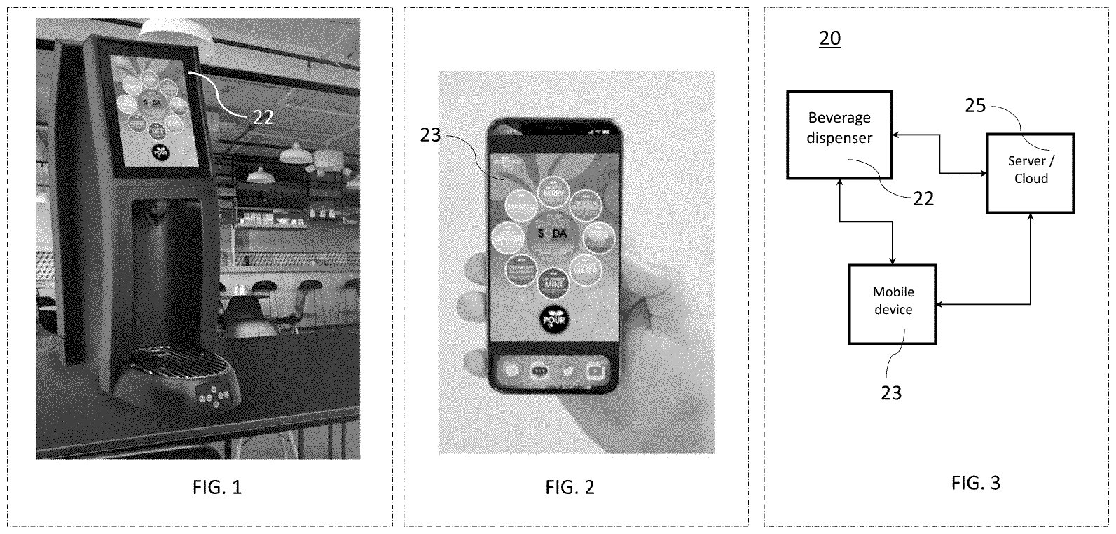

Turning to FIG. 1, an exemplary beverage dispenser 22 is shown. In FIG. 2, an exemplary mobile device 23 used to control the beverage dispenser 22 is shown. In FIG. 3, a schematic diagram of an exemplary beverage dispenser system 20 including the beverage dispenser 22, mobile device 23, and server 25 (e.g., a cloud service provider) is shown.

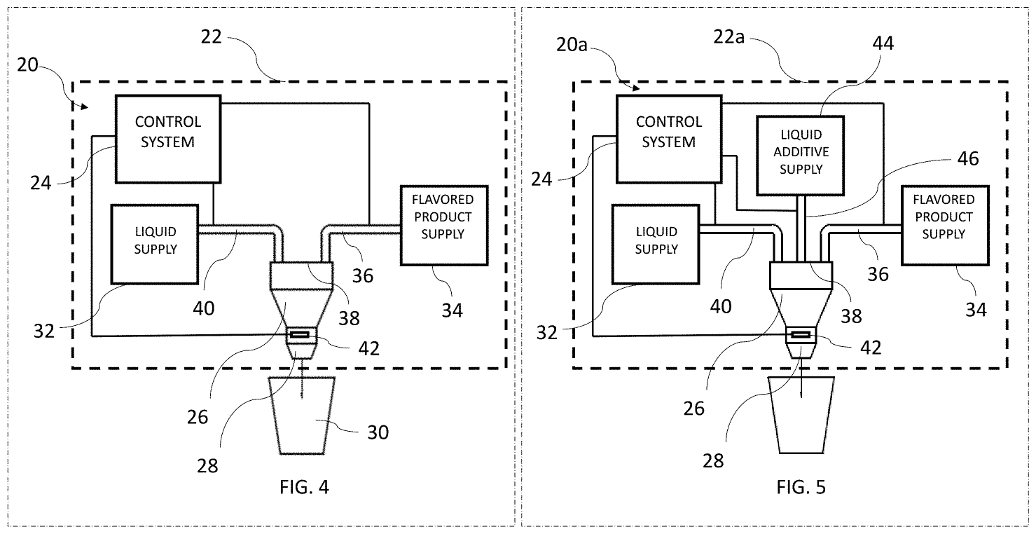

Referring first to FIG. 4, a beverage dispensing system 20 including a beverage dispenser 22 and a control system 24 is schematically shown. The beverage dispenser 22 includes a mixing receptacle 26 in which a flavored mixture is formed and a flavored mixture outlet 28 from which the flavored mixture is dispensed out of the beverage dispenser 22. As used herein, the term “mixture” is not limited to liquid mixtures in which substances are not completely dissolved. Likewise, “solution” is not limited to liquid mixtures in which substances are completely dissolved. For example, the flavored mixture may be dispensed into any suitable container 30 for consumption by a user. The mixing receptacle 26 is fluidly connected to a liquid enclosure 32 containing a supply of liquid and a flavored product enclosure 34 containing a supply of flavored product. The liquid from the liquid enclosure 32 and the flavored product(s) from the flavored product enclosure 34 are supplied to the mixing receptacle 26 where the materials, or ingredients, are mixed to produce the flavored mixture. The mixing receptacle 26 may include any suitable components for blending, emulsifying, homogenizing, or otherwise mixing materials into a single substance. Exemplary components include paddles, blades, or beaters that are motorized.

Alternatively, mixing may be accomplished by controlled injection of the flavored product while dispensing the supply of liquid. The amount of injected flavor may amount of liquid supply and the flow of the liquid supply may dictate the manner and rate at which the flavored product is injected.

The flavored product enclosure 34 is arranged in the beverage dispenser 22 and may be configured to receive, retain, and supply any suitable flavored product to the mixing receptacle 26. For example, the flavored product enclosure (also referred to as the product enclosure) may contain a plurality of flavored products. In exemplary embodiment, the beverage dispenser 22 includes thirty-two flavored products. In this embodiment, a user inputs a requested flavor combination comprising a number of the flavored products via their mobile device 23. Different flavored products (e.g., syrups) may be suitable, including flavors such as cola, diet cola, root beer, ginger ale, lemon lime, orange, ginger beer, black cherry, raspberry, grapefruit, strawberry, etc.

The enclosure 34 may be configured to store the flavored product until use and the enclosure 34 may have any suitable shape and capacity, which may be dependent on the application and the type of flavored. The flavored product enclosure 34 may have any suitable inlet for receiving the powder or liquid flavors and a supply line 36 may be fluidly connected between the flavored product enclosure 34 and the mixing receptacle 26.

Other devices may be provided to transport the flavored product to the mixing receptacle 26 and the devices used may be dependent on whether the product is in powder form or liquid form. Various pumps, valves, motors, and/or pneumatic devices may be arranged along the supply line 36 to move the flavored product along the supply line 36 toward the mixing receptacle 26. The mixing receptacle 26 may be oriented substantially vertically with the supply line 36 and the flavored product enclosure 34 arranged at an upper end 38 of the mixing receptacle 26 such that the flavored product may be assisted by gravity in entering the mixing receptacle 26.

Similarly, the liquid enclosure 32 may also arranged in the beverage dispenser 22 and may also be arranged at the upper end 38 of the mixing receptacle 26 for receiving, retaining, and supplying the liquid to the mixing receptacle 26. The liquid enclosure 32 is arranged independently from the flavored product enclosure 34 to store or hold the liquid and the flavored product separately prior to mixing. Separately containing the materials is advantageous in that the shelf life of the products may be longer prior to mixing. Still another advantage is that the bulk of the materials is separated and the materials may be incrementally mixed to ensure a precise mixture and avoid undesired ratios of flavored to liquid.

A supply line 40 may be fluidly connected between the liquid enclosure 32 and arranged at the upper end 38 of the mixing receptacle 26 such that gravity assists in moving the liquid to the mixing receptacle 26 for mixing with the flavored product. The supply lines 36, 40 used in the beverage dispenser 22 may include any suitable hoses, tubing, and fluid connectors configured for fluid transport. In other embodiments, various pumps, valves, motors, and/or pneumatic devices may be arranged along the supply line 40 to move the liquid toward the mixing receptacle 26. Any suitable liquid may be used and examples of suitable liquids include water, alkaline water, carbonated water, and/or carbonated water that is made with alkaline water. In addition, the liquid may be carbonated at the mixing receptacle, and may have a separate carbonation supply and supply line (not shown) to the mixing receptacle.

During mixing of the liquid and the flavored products (also referred to as flavors), the beverage dispensing system 20 advantageously includes a control system 24 for controlling the amount of the flavored product that is mixed in the liquid. The control system 24 may advantageously provide more precise control of amount of the flavored product that is mixed to ensure desired ratios of the flavored product(s) to the liquid. The control system 24 is communicatively coupled with a control valve 42 that is arranged in the flavored mixture outlet 28 of the mixing receptacle 26. The control valve 42 may be opened, closed, or partially opened or closed by the control system 24 to meter the flavored product being mixed into the liquid prior to dispensing the formed flavored mixture from the flavored mixture outlet 28. The control system 24 may also be communicatively coupled with the supply lines 36, 40 to control the supply of the liquid and the flavored product supply into the mixing receptacle 26. For example, additional control valves may be arranged along the supply lines 36, 40.

Any suitable electronic lines, wiring, cables, harnesses, etc. may be used to connect the control system 24 with the corresponding components of the beverage dispenser 22 and the control system 24 may be automated. Automating the operation enables the control system 24 to maintain a predetermined amount of the flavored product in the dispensed flavored mixture during continuous operation. The predetermined amount may be dependent on the desired beverage product and the solubility of the flavored product within the liquid.

Referring in addition to FIG. 5, another exemplary embodiment of the beverage dispensing system 20a is shown in which the beverage dispenser 22a further includes a liquid additive enclosure 44 that is fluidly connected to the mixing receptacle 26, such as via a supply line 46, for supplying a liquid additive that is mixed with the liquid and the flavored product to form the flavored mixture. The liquid additive enclosure 44 is configured to receive, contain, and supply the liquid additive separately from the flavored product enclosure 34 and the liquid enclosure 32. Like the flavored product enclosure 34 and the liquid enclosure 32, the liquid additive enclosure 44 and supply line 46 may be arranged at the upper end 38 of the mixing receptacle 26. The flavored mixture outlet is arranged at the bottom of the mixing receptacle 26 opposite the supply lines 36, 40, 46.

Using the liquid additive is advantageous in that further variations of beverage products may be produced by the beverage dispenser 22a. The control system 24 of the beverage dispensing system 20a may also be communicatively coupled to the supply line 46 for controlling the amount of liquid additive added to the flavored mixture. A control valve may be arranged along the supply line 46 and communicatively coupled with the control system 24. Accordingly, all of the supply lines 36, 40, 46 may be independently controlled by the control system 24 to achieve a desired flavored mixture. In an exemplary embodiment, the control system 24 may be used to close the supply line 46 for the liquid additive such that the beverage dispenser 22a may operate using only the liquid enclosure 32 and the flavored product enclosure 34 as in the beverage dispenser 22 shown in FIG. 4.

Any suitable liquid additive may be used in the beverage dispensing system 20a. Exemplary liquid additives include syrup, soda, vitamin infused liquids, and combinations thereof. The beverage dispensing systems 20, 20a may be capable of outputting flavored mixtures that include alkaline water, carbonated water made with alkaline water, carbonated water made with alkaline water and vitamin infused soda or sparkling water, and variations thereof. The vitamin infused soda or flavored sparkling water may include a complex vitamin B and C. Liquid additives may include sweeteners such as sucralose or organic cane sugar. Still many other flavored mixtures may be suitable.

In an exemplary embodiment, the flavored product enclosure 34 may include a bag-in-box type configuration in which each of the flavored product(s) is pre-mixed with a fluid prior to being supplied to the mixing receptacle 26 for mixing with the liquid. The flavored product may be a syrup or any suitable fluid.

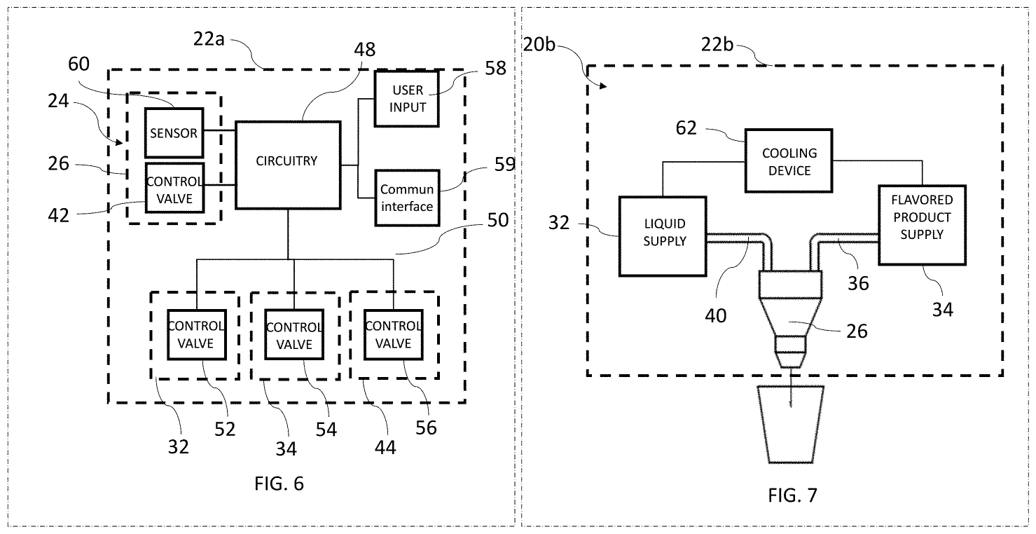

Referring now to FIG. 6, an exemplary embodiment of the control system 24 for the beverage dispenser 22a is shown. The control system 24 (also referred to as circuitry) includes a processor 48 and a controller 50 communicatively coupled to the processor 48. The control system 24 may include any suitable electronic control mechanism, such as, for example, a central processing unit (CPU), a microprocessor, control circuitry, and other suitable components. The controller 50 may be communicatively coupled between the processor 48 and control valves 52, 54, 56 that correspond to the liquid enclosure 32, the flavored product enclosure 34, and the liquid additive enclosure 44, respectively. The control valves 42, 52, 54, 56 may have any suitable configuration or components to directly control the flow rate. The control valves may be rotary, having balls, butterfly or plug type closures, or linear, having globe, diaphragm or pinch type closures. Any suitable type of actuator may be used for the valves, such as a piston or diaphragm that is pneumatic, electric, or a combination thereof. Electromechanically operated valves including solenoid valves may also be suitable. Many other types of control valves may be suitable.

The processor 48 is configured to provide instructions to the controller 50 to adjust the control valves 52, 54, 56 for controlling amounts of the liquid, flavored product(s), and liquid additive during mixing. The beverage dispenser 22 may also include a user input 58 for receiving an input from a user. The user input 58 may include any suitable user interface, such as a touch-type screen displaying a graphical user interface. The processor 48 may be configured to operate the controller 50 and the control valves 42, 52, 54, 56 based on the user input 58. For example, the user input 58 may be used to selectively add the liquid additive and/or flavored product based on the user's preference.

As opposed to receiving instructions from the user input 58, the control system 24 is configured to also receive instructions from a mobile device 23 via a communication interface 59. The communication interface 59 is connected to the mobile device via a wireless connection and receives instructions from the mobile device 23. The received instructions include a user identifier (ID) and selected flavor(s). The user ID may be a unique identifier for the user of the mobile device 23 that is used for billing and/or logging purposes by a server 25 as is described below.

The communication interface 59 is communicatively coupled to the control system and identifies the selected flavors. The communication interface 59 receives instructions from the mobile device 23. In particular, the communication interface 59 is in wireless communication with a network interface of the mobile device 23. The communication interface may comprise a wireless network adaptor, an Ethernet network card, a near field communication (NFC) antenna, or any suitable device that provides an interface between the communication interface of the beverage dispenser and the network interface of the mobile device. The communication interface may additional communicate with the server 25 via a network such as the internet, such that the communication interface is able to send data stored on a computer readable medium of the beverage dispenser across the network and store received data on the computer readable medium (e.g., data based on the instructions received from the mobile device). As described above, the communication interface is also communicatively coupled to the control system such that the control system is able to control operation of the beverage dispenser based on instructions received by the communication interface. The communication interface, computer readable medium, and circuitry may be communicatively coupled through a system bus, mother board, or using any other suitable manner as will be understood by one of ordinary skill in the art.

The beverage dispenser 22 and the mobile device 23 may communicate using a wireless signal having a limited effective distance. For example, the beverage dispenser 22 and the mobile device 23 may communicate using a protocol having a maximum effective distance of two feet or less (e.g., NFC) such that a user does not mistakenly cause a beverage dispenser 22 to dispense a beverage when the user is across the room from the beverage dispenser 22.

The mobile device 25 includes a processor configured to execute an app stored in a non-transitory computer readable memory and send the instructions to the mobile device via the network interface. As described above, the instructions include a user identifier (ID) and at least one selected flavor. The instructions further include either a desired volume to be dispensed (e.g., represented in ounces, milliliters, etc.) or a signal indicating when the flavored mixture should be dispensed by the beverage dispenser. For example, the mobile device 25 may provide an initial instruction to begin dispensing the flavored mixture and a second instructions when to stop dispensing the flavored mixture, such that the flavored mixture is dispensed in the time between receipt of the first instructions and the second instruction.

Alternatively, the mobile device 25 may provide instructions at a specified frequency indicating when the flavored mixture should be dispensed. For example, a first instruction may be received by the beverage dispenser 22 indicating the user ID, selected flavor(s) (which may include no selected flavors and instead simply a type of water (e.g., sparkling, flat, etc.)), and an instruction to begin dispensing the flavored mixture. The beverage dispenser 22 may then begin dispensing the flavored mixture when the first instruction is received. The beverage dispenser 22 may continue to dispense the flavored mixture as long as a further instruction is received within a period of time (e.g., 500 ms) to continue dispensing the flavored mixture. The beverage dispenser 22 may stop dispensing the flavored mixture when an instruction to continue dispensing the flavored mixture is not received and/or when an instruction is received to stop dispensing the flavored mixture. In one embodiment, the beverage dispenser 22 may stop dispensing the flavored mixture when a threshold volume (e.g., 12 ounces) has been dispensed.

As shown in FIGS. 1 and 2, the app executed on the mobile device 23 may cause the mobile device 23 to display a graphical user interface mirroring a graphical user interface displayed on the user input of the beverage dispenser 22.

The beverage dispenser 22 may include a volume sensor configured to measure a volume of fluid dispensed by the beverage dispenser 22. The volume sensor may be any suitable sensor for determining a dispensed volume of fluid. For example, the volume sensor may be a flow sensor and the output of the flow sensor may be used to determine a dispensed volume over a period of time. As another example, the volume sensor may be implemented by the processor and may estimate the dispensed volume based on the time that fluid was dispensed by the beverage dispenser 22 based on a known flow rate of the beverage dispenser 22.

The beverage dispenser 22 may be configured to communicate with a server 25 via the communication interface. For example, the beverage dispenser 22 may communicate with the server over a network such as the internet. The beverage dispenser 22 may communicate to the server 25 the user ID and at least one of the measured volume or the at least one selected flavor. For example, when a user selects flavors (or no flavors) and a type of water to be dispensed and causes the selected beverage to be dispensed, the beverage dispenser 22 may inform the server 25 of the user ID of the user, the selected flavors, the type of water, and the volume of the beverage that was dispensed. The beverage dispenser 22 may also provide to the server 25 a cost of the flavor mixture that was dispensed per unit of volume.

Upon receiving this information, the server 25 may generate a bill against a user's account that is associated with the received user ID. In this way, the beverage dispenser 22 may allow a user to purchase a beverage from a beverage dispenser 22 without touching anything except their mobile device 22 (e.g., a mobile phone or tablet) and the container that the requested beverage is dispensed into.

The beverage dispenser system allows a company to bill users automatically and to provide reports detailing usage of the beverage dispenser(s). For example, a university may have a meal plan that allows students to purchase a certain dollar amount of beverages each month and the university may have multiple beverage dispensers 22 spread across the university. A student may use any one of the beverage dispensers 22 via their mobile phone 23 and the beverage dispenser system 20 may track student usage and provide notifications when the student approaches their dollar allotment for a given time period.

The server may also provide a report to users detailing the beverages, volumes of fluid, and optionally nutritional information of the beverages consumed. This report may be provided to a service that the user is a member of (e.g., Fitbit, Apple Health, etc.).

The control system 24 may further include at least one sensor 60 that is communicatively coupled with the processor 48 for automatically controlling the levels of the liquid, the flavored product, and the liquid additive. More than one sensor may be used and at least one sensor 60 may be arranged in the flavored mixture outlet 28 of the mixing receptacle 26. Any suitable type of sensor 60 may be used including fluid level, pressure, temperature or thermometer, potentiometer, conductivity, biosensors, and optical sensors. Other types of sensors may be suitable such as any sensor that is configured to measure temperature, pH, acidity, water activity, or other conditions such as those that control or prevent undesirable microorganisms in the beverage product.

Arranging the sensor 60 in the flavored mixture outlet 28 ensures that the flavored mixture to be dispensed has the desired amount of ingredients and the control system 24 may be configured to adjust the amounts based on the conditions detected by the sensor 60. In exemplary embodiments, the control valve 42 may be opened, closed, or partially opened or closed during adjustment. In other exemplary embodiments, a recirculation line may be provided such that if the sensor 60 detects that a flavored mixture in the flavored mixture outlet 28 does not satisfy a predetermined threshold for a particular condition, the flavored mixture may be rerouted back to the mixing receptacle 26 for further mixing. The recirculation line may include any valving, pumps, or fluid lines for recirculating the undesirable flavored mixture.

Referring now to FIG. 7, another exemplary embodiment of the beverage dispensing system 20b is shown in which the beverage dispenser 22b is configured to use at least one of a cooled liquid or a cooled flavored product supply. The beverage dispensing system 20b may include at least one cooling device 62 which includes a single cooling device or two separate cooling devices for the liquid and the flavored product(s). In an exemplary embodiment, the cooling device 62 may be fluidly connected to the supply line 40 for cooling the liquid as the liquid travels from the liquid enclosure 32 to the mixing receptacle 26. The cooling device 62 may be configured to cool the liquid, such as water, to a temperature that is between 1 and 8 degrees Celsius (between 35 and 45 degrees Fahrenheit). The cooling temperature may be dependent on the liquid and the temperature may be dependent on whether the liquid is being stored or moving toward the mixing receptacle 26. To maintain cool temperatures, a supply line may be thermally insulated.

The same cooling device 62 (or a second cooling device) may also be provided for the flavored product. The cooling device 62 may also be fluidly connected to the flavored product enclosure 34 or to the supply line 36. The cooling devices 62 may be configured to maintain a predetermined temperature of the liquid and/or the flavored product during storage and during operation. In exemplary embodiments, only the cooling device 62 for the liquid may be provided such that only the liquid is cooled. Any suitable cooling device or components may be used to cool the liquid or the flavored product, including heat exchangers, desiccants, insulators, evaporators, condensers, compressors, expansion valves, cooling fans, etc.

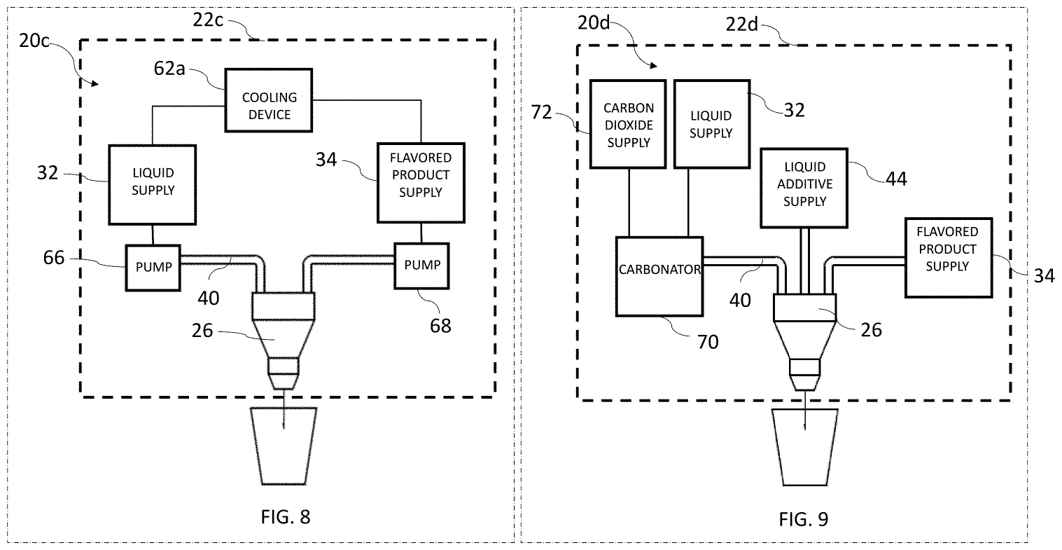

Referring in addition to FIG. 8, still another embodiment of the beverage dispensing system 20c is shown in which the beverage dispenser 22c further includes pumps 66, 68 for pumping the materials from the liquid enclosure 32 and the flavored product enclosure 34 to the mixing receptacle 26. As shown in the exemplary embodiment of FIG. 8, the cooling device 62a for the liquid may be fluidly connected to the liquid enclosure 34 rather than the supply line 40. In still other exemplary embodiments, cooling devices may be fluidly connected to both the enclosures and the supply lines for the liquid and/or the flavored product.

Referring now to FIG. 9, still another embodiment of the beverage dispensing system 20d is shown in which the beverage dispenser 22d further includes a carbonator 70 for carbonating the liquid from the liquid enclosure 32. The carbonator 70 is fluidly connected to a carbon dioxide supply 72 and the liquid enclosure 32 such that the carbonator 70 is configured to receive the liquid from the liquid enclosure 32. The supply line 40 is fluidly connected to the carbonator 70 for transferring the carbonated liquid to the mixing receptacle 26 for mixing with the flavored product received from the flavored product enclosure 34. In exemplary embodiments, liquid additive may also be mixed in. The carbonator 70 may include any suitable valves or control lines and a control system for the beverage dispenser 22d may also be configured to operate the carbonator 70.

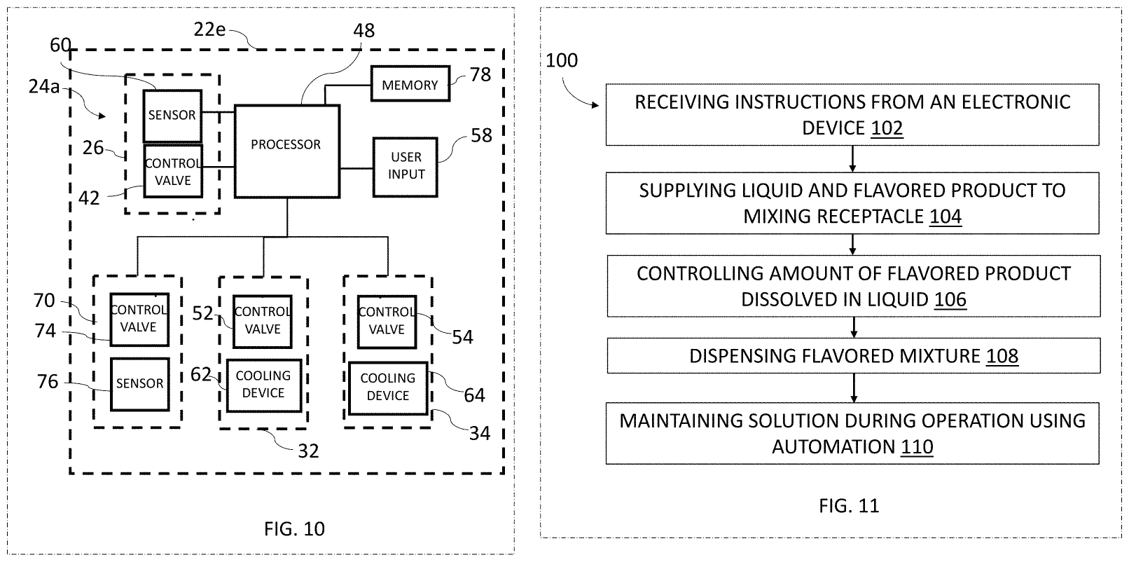

Referring in addition to FIG. 10, an exemplary control system 24a is shown in a beverage dispenser 22e that includes the carbonator 70 having a control valve 74 and a sensor 76, the liquid enclosure 32 including the control valve 52 and the cooling device 62, the flavored product enclosure 34 including the control valve 54, and the control valve 42 arranged in the mixing receptacle 26. The control system 24a operates similarly to the control system 24 of FIG. 6 and the configurations shown in FIGS. 3 and 7 are merely exemplary. More or fewer components of the beverage dispenser may be included and the components may depend on the application. For example, the carbonator 70 may be provided without one or any of the cooling devices and/or the liquid additive enclosure 44 shown in the control system 24 of FIG. 6 may be provided. The control system 24a includes the processor 48, the user input 58, and the controller 50 that is communicatively coupled with the carbonator 70, the liquid enclosure components 52, 62, and the flavored product components 54.

The control system 24a is configured to control the control valves 42, 52, 54, 74 and the cooling device 62. The sensors 60, 76 may be used to detect certain conditions and the processor 48 may be used to operate the controller 50 based on the detected conditions. The control system 24a may be configured for automatic operation and/or may also receive manual inputs from the user input 58. A memory 78 may also be provided in the control system 24a for containing stored data pertaining to recipes for particular beverage flavored mixtures. The stored data may also pertain to predetermined conditions or thresholds for the sensors. Examples of predetermined conditions or thresholds may include fluid levels, pressure, temperature, viscosity, etc. The processor 48 is communicatively coupled to the memory 78 and may provide instructions to the control valves and/or other components based on comparing the detected data and the stored data.

Referring now to FIG. 11, a flow chart showing a method 100 of controlling an amount of a flavored product in a flavored mixture of the flavored product and a liquid that is dispensed from a beverage dispenser is shown. The method 100 may include using the beverage dispenser 22, 22a, 22b, 22c, 22d, 22e shown in FIGS. 4-10. A first step 102 of the method 100 includes receiving instructions from the mobile device 23. As described above, the instructions are received via the communication interface 59.

A second step 104 of the method 100 includes supplying the liquid and the flavored product to the mixing receptacle 26 to form the flavored mixture. Step 102 may include storing the liquid and the flavored product, and using supply lines, pumps, etc. to transfer the material to the mixing receptacle 26. Supplying the flavored product may include supplying a powder material, a liquid, or a solution thereof and supplying the liquid may include supplying at least one of water, carbonated water, syrup, soda, tea, coffee, or a combination thereof.

Supplying the liquid may include cooling the liquid such as by using the cooling device 62, 62a shown in FIGS. 4 and 5. Step 104 may further include carbonating the liquid and supplying the carbonated liquid to the mixing receptacle 26, such as by using the carbonator 70 shown in FIG. 9. The supplying step 104 may further include supplying a liquid additive to the mixing receptacle 26 to be added to the flavored mixture.

Step 106 of the method 80 includes controlling an amount of the flavored product that is dissolved in the liquid. Step 106 may include using the control system 24, 24a shown in FIGS. 6 and 10. For example, control valves, such as the control valves 42, 52, 54, 74 shown in FIG. 10 may be operated based on sensed conditions to achieve a specific beverage flavored mixture. In exemplary embodiment in which the liquid additive enclosure 44 of FIG. 5 is provided, step 84 may include controlling an amount of the liquid additive that is added to the flavored mixture. Controlling the liquid additive may include using the control valve 56 shown in FIG. 6. When the flavored mixture has the desired solution, step 108 of the method 100 includes dispensing the flavored mixture. For example, the flavored mixture may be dispensed into the consumption container 30 shown in FIG. 4.

Step 110 of the method 100 includes optionally maintaining a predetermined solution of the flavored mixture. The control system 24, 24a may be configured to automatically maintain the solution by determining a level of the flavored product in the mixing receptacle 26 using a product level sensor 60, as shown in FIGS. 3 and 7, and controlling the control valves 42, 52, 54, 74 based on the determined level. Maintaining the solution may include maintaining the solution to have between 15 and 25 milligrams of the flavored product per 240 milliliters of the flavored mixture. Other solutions may also be suitable and are dependent on the beverage product.

Using the beverage dispenser, system, and method described herein is advantageous in both producing a beverage flavored mixture using a separate mobile device that does not require a user to physically touch the beverage dispenser.

Although the invention has been shown and described with respect to a certain embodiment or embodiments, it is obvious that equivalent alterations and modifications will occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein illustrated exemplary embodiment or embodiments of the invention. In addition, while a particular feature of the invention may have been described above with respect to only one or more of several illustrated embodiments, such feature may be combined with one or more other features of the other embodiments, as may be desired and advantageous for any given or particular application.

1. A beverage dispenser comprising:
a liquid enclosure that includes a liquid control valve and that is configured to contain a liquid;
a mixing receptacle that is fluidly connected with the liquid control valve and includes a flavored mixture outlet;
a product enclosure that includes a flavor control valve and is configured to contain at least one flavored product separately from the liquid, wherein the flavor control valve is fluidly connected to the mixing receptacle for mixing the at least one flavored product with the liquid to form a flavored mixture that is dispensed from the flavored mixture outlet and a control valve;
a communication interface configured to wirelessly receive instructions from a mobile device; and
control system including circuitry communicatively coupled with the liquid control valve and the flavor control valve for maintaining a predetermined amount of each of the at least one flavored product in the dispensed flavored mixture based on the received instructions.

2. The beverage dispenser according to claim 1, further comprising a product level sensor arranged in the flavored mixture outlet and communicatively coupled with the circuitry, wherein the circuitry automatically operates the liquid control valve and the product control valve in response to sensed levels of the flavored product in the flavored mixture outlet.

3. The beverage dispenser according to claim 2, further comprising a display including a user interface for receiving beverage selections from a user, wherein the circuitry is configured to receive the beverage selections from the display.

4. The beverage dispenser of claim 1, wherein the instructions received by the communication interface include a user identification (ID) and at least one selected flavor of the at least one flavored product.

5. The beverage dispenser of claim 4, further comprising a flow sensor configured to measure a volume of the flavored mixture dispensed from the flavored mixture outlet, wherein:
the circuitry is further configured to communicate to a server via the communication interface the user ID and at least one of the measured volume or the at least one selected flavor.

6. The beverage dispenser of claim 5, wherein the circuitry is configured to communicate to the server the user ID, the measured volume, and the at least one selected flavor.

7. The beverage dispenser of claim 4, wherein:
instructions received by the communication interface further include a requested volume; and
the circuitry is further configured to communicate to a server via the communication interface the user ID and at least one of the requested volume or the at least one selected flavor.

8. The beverage dispenser of claim 5, wherein the circuitry is configured to communicate to the server the user ID, the requested volume, and the at least one selected flavor.

9. The beverage dispenser according to claim 1, wherein:
the at least one flavored product comprises at least two flavored products; and
the received instructions specify an amount of each of the at least one flavor product in the flavored mixture.

10. The beverage dispenser according to claim 1, wherein the received instructions specifies an amount of zero for a particular flavor product of the at least two flavored products, such that none of the particular flavor product is included in the flavored mixture.

11. The beverage dispenser according to claim 1, wherein the communication interface communicates with the mobile device via a Bluetooth, WIFI, or near-field communication (NFC).

12. The beverage dispenser according to claim 1 further comprising a cooling device that is fluidly connected to the liquid enclosure and cools the liquid.

13. The beverage dispenser according to claim 1 further comprising:
a carbon dioxide supply; and
a carbonator fluidly connected to the carbon dioxide supply and fluidly connected between the liquid enclosure and the mixing receptacle.

14. The beverage dispenser according claim 1 wherein the product enclosure is configured to contain the at least one flavored product that is a powder material, a liquid, or a solution thereof.

15. The beverage dispenser according to claim 1, wherein the liquid enclosure is configured to contain the liquid that includes at least one of water, carbonated water, syrup, soda, tea, coffee, or a combination thereof.

16. The beverage dispenser according to claim 1, wherein the liquid enclosure includes a pump and a supply line connected between the pump and the mixing receptacle.

17. The beverage dispenser according to claim 1, wherein the product enclosure includes a pump and a supply line connected between the pump and the mixing receptacle.

18. A beverage dispenser system comprising:
a beverage dispenser including:
a liquid enclosure that includes a liquid control valve and that is configured to contain a liquid;
a mixing receptacle that is fluidly connected with the liquid control valve and includes a flavored mixture outlet;
a product enclosure that includes a flavor control valve and is configured to contain at least one flavored product separately from the liquid, wherein the flavor control valve is fluidly connected to the mixing receptacle for mixing the at least one flavored product with the liquid to form a flavored mixture that is dispensed from the flavored mixture outlet and a control valve;
a communication interface configured to wirelessly receive instructions; and
a control system including circuitry communicatively coupled with the liquid control valve and the flavor control valve for maintaining a predetermined amount of each of the at least one flavored product in the dispensed flavored mixture based on the received instructions.
a mobile device including:
a network interface configured to wirelessly send instructions to the communication interface of the beverage dispenser;
a processor configured to execute an app stored in a non-transitory computer readable memory and send the instructions to the beverage dispenser via the network interface, wherein the instructions include a user identifier (ID) and at least one selected flavor of the at least one flavored product.

19. The beverage dispenser system of claim 19, wherein:
the beverage dispenser further comprises a display including a user interface for receiving beverage selections from a user; and
the app is configured to display an interface based on the user interface of the display of the beverage dispenser for receiving beverage selections from the user.

20. The beverage dispenser system of claim 18, further comprising a server connected via a network to the mobile device, wherein the processor of the mobile device is configured to send the user ID and at least one selected flavor of the at least one flavored product.

21. The beverage dispenser system of claim 20, wherein the server comprises a billing server configured to charge a user of the mobile device based on the received user ID and the selected flavor.

22. The beverage dispenser system of claim 20, wherein the server comprises a health monitoring server configured to log the received information in association with the user ID.

23. A method of controlling an amount of a flavored product in a flavored mixture of the flavored product and a liquid that is dispensed from a beverage dispenser, the method comprising:
wirelessly receiving, using a communication interface, instructions from a mobile device;
supplying a liquid to a mixing receptacle by using the circuitry to control a liquid control valve based on the received instructions;
supplying at least one flavored product to the mixing receptacle to be dissolved in the liquid and form a flavored mixture by using the circuitry to control a flavor control valve based on the received instructions; and
modulating an amount of the at least one flavored product that is dissolved in the liquid to maintain a predetermined solution of the flavored mixture that is dispensed from the beverage dispenser by using the circuitry to control a control valve based on the received instructions.
